(19) United States
(12) Patent Application Publication
(10) Pub. No.: US 2020/0040132 A1
(43) Pub. Date: Feb. 6, 2020

(54) PROCESS FOR PRODUCING A LOW VISCOSITY POLYESTER POLYOL

(71) Applicant: FAR EASTERN NEW CENTURY CORPORATION, Taipei City (TW)

(72) Inventors: Der-Ren HWANG, Taipei City (TW); Cheng-Ting WANG, Taipei City (TW); Ya-Ying CHANG, Taipei City (TW); Chun-Chieh CHIEN, Taipei City (TW)

(73) Assignee: FAR EASTERN NEW CENTURY CORPORATION, Taipei City (TW)

(21) Appl. No.: 16/261,442

(22) Filed: Jan. 29, 2019

(30) Foreign Application Priority Data
Aug. 2, 2018 (TW) 107126961

(51) Int. Cl. C08G 63/183; C08G 63/83

(52) U.S. Cl. CPC C08G 63/183; C08G 63/83

(57) ABSTRACT

A process for producing a low viscosity polyester polyol includes the steps of:
(a) preparing a mixture which includes an aromatic diacid-based compound, an alkali metal ion-containing compound, and an aliphatic diol compound; and
(b) subjecting the mixture to a reaction,
wherein the alkali metal ion-containing compound has an alkali metal ion content of from 10 ppm to 12000 ppm based on a total weight of the mixture.

### CROSS-REFERENCE TO RELATED APPLICATION

This application claims priority to Taiwanese Application No. 107126961, filed on Aug. 2, 2018, the disclosure of which is incorporated herein by reference in its entirety.

### FIELD

The disclosure relates to a process for producing a polyester polyol, and more particularly to a process for producing a low viscosity polyester polyol.

### BACKGROUND

Polyester polyol is a polyol formed by the condensation reaction of diacids and diols, and is widely used for producing polyurethane synthetic leather, polyurethane foam, polyurethane/polyisocyanurate foam, adhesive, coating, thermoplastic polyurethane, and the like. When the polyester polyol has a viscosity that is too high, the dispersibility thereof becomes unsatisfactory such that subsequent processing of the polyester polyol may be difficult. Therefore, the viscosity of the polyester polyol should be properly adjusted and controlled in view of ease of the subsequent processing and application of the polyester polyol.

U.S. Pat. No. 6,664,363 B1 discloses a method for preparing a low viscosity aromatic polyester polyol. The method comprises a step of subjecting the following components to an inter-esterification reaction: (a) 20-80 mol % of at least one phthalic acid-based material, (b) 20-80 mol % of at least one low molecular weight aliphatic diol, (c) 0.1-20 mol % of a higher functional polyol, and (d) 0.1-20 mol % of at least one hydrophobic material. Examples of the higher functional polyol include alkoxylated glycerine, sucrose, alkoxylated sucrose, and the like. Examples of the hydrophobic material include carboxylic acids such as fatty acids, lower alkanol esters of carboxylic acids, triglycerides, and the like.

Japanese Patent Publication No. 2013-023558A discloses a low viscosity polyester polyol which is obtained by esterification of a carboxylic acid component containing isophthalic acid and/or terephthalic acid and an alcohol component containing polyethylene glycol having a number average molecular weight of 200 to 1000 and polypropylene glycol having a number average molecular weight of 200 to 1000.

In the prior art described above, the viscosity of the polyester polyol is lowered by modifying the acid component and/or the alcohol component in the formulation for preparing the polyester polyol. However, modification of the acid component and/or the alcohol component may result in variation of the process conditions, and may also significantly increase the research-and-development period, the production cost, and the like. Therefore, it is desirable in the art to develop a process for producing a low viscosity polyester polyol without substantial variation in the formulation and the process conditions.

### SUMMARY

Therefore, an object of the disclosure is to provide a process for producing a low viscosity polyester polyol to overcome the aforesaid shortcomings of the prior art.

According to the disclosure, there is provided a process for producing a low viscosity polyester polyol, comprising the steps of:

(a) preparing a mixture which includes an aromatic diacid-based compound, an alkali metal ion-containing compound, and an aliphatic diol compound; and

(b) subjecting the mixture to a reaction,

wherein the alkali metal ion-containing compound has an alkali metal ion content of from 10 ppm to 12000 ppm based on a total weight of the mixture.

### DETAILED DESCRIPTION

A process for producing a low viscosity polyester polyol according to the disclosure comprises the steps of:

(a) preparing a mixture which includes an aromatic diacid-based compound, an alkali metal ion-containing compound, and an aliphatic diol compound; and

(b) subjecting the mixture to a reaction,

wherein the alkali metal ion-containing compound has an alkali metal ion content of from 10 ppm to 12000 ppm based on a total weight of the mixture.

In the process for producing a low viscosity polyester polyol according to the disclosure, the reaction of the aromatic diacid-based compound with the aliphatic diol compound is controlled via addition of the alkali metal ion-containing compound so as to produce the low viscosity polyester polyol. While not bound by any theory, it is believed that the alkali metal ion-containing compound may be used as an end-capping agent for the aromatic diacid-based compound and/or the aliphatic diol compound, primarily the aromatic diacid-based compound, and/or the polyester polyol thus produced. Specifically, hydrogen ions contained in terminal COOH and/or OH groups of the aromatic diacid-based compound, the aliphatic diol compound, and/or the polyester polyol are replaced with the alkali metal ions contained in the alkali metal ion-containing compound so as to prevent excessive chain extension (i.e., excessive polymerization) of the polyester polyol. Therefore, the undesired significant increase of the molecular weight and the viscosity of the polyester polyol thus produced can be avoided.

The term “an aromatic diacid-based compound” as used herein specifically refers to aromatic dicarboxylic acid-based compound which includes aromatic dicarboxylic acid and derivatives thereof. In certain embodiments, the aromatic diacid-based compound is selected from the group consisting of an aromatic dicarboxylic acid, an aromatic dicarboxylic anhydride, and a combination thereof. In certain embodiments, the aromatic diacid-based compound is a benzenedicarboxylic acid-based compound. Examples of the benzenedicarboxylic acid-based compound include, but are not limited to, phthalic acid, phthalic anhydride, terephthalic acid, and isophthalic acid. The examples of the benzenedicarboxylic acid-based compound may be used alone or in admixture of two or more thereof. The aromatic diacid-based compound used in the following illustrated examples includes phthalic acid, terephthalic acid, isophthalic acid, and combinations thereof.

The term “an alkali metal ion-containing compound” as used herein generally refers to any compound containing alkali metal ion. In certain embodiments, the alkali metal ion-containing compound is selected from the group consisting of an alkali metal hydroxide, an alkali metal salt, and a combination thereof. Examples of the alkali metal hydroxide include, but are not limited to, sodium hydroxide and potassium hydroxide. The examples of the alkali metal hydroxide may be used alone or in admixture of two or more thereof. Examples of the alkali metal salt include, but are not limited to, sodium carbonate, sodium hydrocarbonate, sodium chloride, sodium sulfate, and potassium carbonate. The examples of the alkali metal salt may be used alone or in admixture of two or more thereof. The alkali metal ion-containing compound used in the following illustrated examples includes sodium carbonate, sodium hydrocarbonate, sodium chloride, sodium sulfate, and potassium hydroxide.

The term “an aliphatic diol compound” as used herein generally refers to any aliphatic diol compound which is reactive with the aromatic diacid-based compound. Examples of the aliphatic diol compound include, but are not limited to, ethylene glycol, diethylene glycol, 2-[2-(2-hydroxyethoxy)ethoxy]ethanol, propylene glycol, 1,4-butanediol, 1,2-pentanediol, hexanediol, neopentyl glycol, 1,4-cyclohexane-dimethanol, 1,2-cyclohexane-dimethanol, 1,3-cyclohexane-dimethanol, tetramethyl cyclobutanediol, and isosorbide. The examples of the aliphatic diol compound may be used alone or in admixture of two or more thereof. The aliphatic diol compound used in the following illustrated examples includes ethylene glycol and diethylene glycol.

Step (a) is performed under conditions at which the aromatic diacid-based compound and the aliphatic diol compound do not react with each other. In step (a), the alkali metal ion-containing compound is used as an end-capping agent such that a portion of the hydrogen ions contained in terminal COOH and/or OH groups of the aromatic diacid-based compound and/or the aliphatic diol compound is replaced with the alkali metal ions contained in the alkali metal ion-containing compound so as to control the subsequent reaction of the aromatic diacid-based compound with the aliphatic diol compound. The aromatic diacid-based compound, the alkali metal ion-containing compound, and the aliphatic diol compound may be mixed in any order under the conditions at which the aromatic diacid-based compound and the aliphatic diol compound do not react with each other. In certain embodiments, step (a) is implemented by the sub-steps of:

(a1) premixing the aromatic diacid-based compound with the alkali metal ion-containing compound to obtain a pre-mixture; and

(a2) mixing the pre-mixture with the aliphatic diol compound to obtain the mixture.

In step (a), as described above, the alkali metal ion-containing compound has an alkali metal ion content of from 10 ppm to 12000 ppm based on a total weight of the mixture. When the alkali metal ion content is larger than 12000 ppm, the polyester polyol thus produced may have an undesirable cloudy appearance, which may negatively affect the appearance and the application of articles made by the polyester polyol. On the other hand, when the alkali metal ion content is less than 10 ppm, the alkali metal ion-containing compound cannot have a satisfactory end-capping effect for the hydrogen ions contained in terminal COOH and/or OH groups of the aromatic diacid-based compound and/or the aliphatic diol compound. In certain embodiments, the alkali metal ion content of the alkali metal ion-containing compound is from 50 ppm to 11000 ppm based on a total weight of the mixture.

In the mixture of step (a), the amounts of the aromatic diacid-based compound and the aliphatic diol compound can be adjusted according to the specific aromatic diacid-based compound and/or the specific aliphatic diol compound for preparing the mixture, the properties (for example, acid value, hydroxyl value, and the like) of the polyester polyol to be produced, or the like. In certain embodiments, a weight ratio of the aliphatic diol compound to the aromatic diacid-based compound is in a range of from 1.0 to 1.5.

In certain embodiments, the mixture prepared in step (a) further includes an aliphatic diacid-based compound. The term “aliphatic diacid-based compound” as used herein refers to an aliphatic dicarboxylic acid-based compound which includes aliphatic dicarboxylic acid and derivatives thereof. In certain embodiments, the aliphatic diacid-based compound is selected from the group consisting of aliphatic diacid, aliphatic dianhydride, and a combination thereof. Examples of the aliphatic diacid include, but are not limited there, maleic acid, fumaric acid, succinic acid, glutaric acid, adipic acid, suberic acid, sebacic acid, α-ketoglutaric acid, and oxaloacetic acid. The examples of the aliphatic diacid may be used alone or in admixture of two or more thereof. Examples of the aliphatic dianhydride include, but are not limited to, maleic anhydride and succinic anhydride. The aliphatic diacid-based compound used in the following illustrated examples includes maleic anhydride and fumaric acid. When the aliphatic diacid-based compound is included in the mixture of step (a), the amounts of the aromatic diacid-based compound, the aliphatic diacid-based compound, and the aliphatic diol compound can be adjusted according to the specific aromatic diacid-based compound, the specific aliphatic diacid-based compound, and the specific aliphatic diol compound for preparing the mixture, the properties (for example, acid value, hydroxyl value, and the like) of the polyester polyol to be produced, or the like. In certain embodiments, a weight ratio of the aliphatic diol compound to a combination of the aromatic diacid-based compound and the aliphatic diacid-based compound is in a range of from 1.0 to 1.5.

The reaction in step (b) includes, for example, an esterification or transesterification reaction, followed by a polycondensation reaction.

In certain embodiments, the reaction in step (b) is implemented in the presence of a catalyst. Examples of the catalyst include, but are not limited to, an acid, an organic tin compound, and a titanium-containing compound. The examples of the catalyst may be used alone or in admixture of two or more thereof. Examples of the acid include, but are not limited to, sulfuric acid, phosphoric acid, and p-toluenesulfonic acid. A non-limiting example of the organic tin compound is dibutyl tin(IV) dilaurate. Examples of the titanium-containing compound include, but are not limited to, titanium (IV) isopropoxide and titanium (IV) n-butoxide. The catalyst used in the following illustrated examples is titanium (IV) n-butoxide.

The temperature for the reaction in step (b) can be adjusted by one skilled in the art according to, for example, the reactants and the equipments for the reaction, the properties of the polyester polyol to be produced, and the like. In certain embodiments, the temperature for the reaction in step (b) is in a range of from 180° C. to 220° C. The temperature for the reaction in step (b) in the following illustrated examples is 200° C.

The properties such as viscosity, acid value, hydroxyl value, and appearance of the polyester polyol thus produced by the process according to the disclosure can be adjusted depending on the subsequent process conditions and application of the polyester polyol. The viscosity of the polyester polyol is a property of primary concern. In certain embodiments, the viscosity of the polyester polyol thus produced is in a range of up to 10000 cP at 25° C. In certain embodiments, the viscosity of the polyester polyol thus produced is in a range of up to 7000 cP at 25° C. The appearance of the polyester polyol is a property of secondary concern. In certain embodiments, the polyester polyol thus produced is transparent. In certain embodiments, the polyester polyol thus produced is transparent and colorless.

In certain embodiments, the acid value of the polyester polyol thus produced by the process according to the disclosure is controlled within a range of up to 5 mg KOH/q, in view of the application of the polyester polyol for forming foam products. In the following illustrated examples, the acid value of the polyester polyol thus produced is controlled within a range of up to 3 mg KOH/g. In certain embodiments, the hydroxyl value of the polyester polyol thus produced by the process according to the disclosure is controlled within a range of up to 500 mg KOH/g. In the following illustrated examples, the hydroxyl value of the polyester polyol thus produced is controlled within a range of up to 400 mg KOH/g.

The polyester polyol produced by the process according to the disclosure can be used for producing polyurethane synthetic leather, polyurethane foam, adhesive, coating, thermoplastic polyurethane, and the like. The polyester polyol thus produced in the following illustrated examples has an acid value of less than 5 mg KOH/g and is especially suitable for producing polyurethane/polyisocyanurate foam.

Examples of the disclosure will be described hereinafter. It is to be understood that these examples are exemplary and explanatory and should not be construed as a limitation to the disclosure.

### Property Measurements:

The alkali metal ion content, the acid value, the hydroxyl value, and the viscosity of the polyester polyol thus obtained in each of the following examples and comparative examples were measured according to the procedures described below.

1. Practical Content of Alkali Metal Ion (in ppm):

A portion of a polyester polyol product was taken after the reaction was completed, and the practical content of the alkali metal ion in the polyester polyol product was measured using an inductively coupled plasma mass spectrometer (Model: VG Elemental PQ3).

### 2. Acid Value:

### (i) Preparation of a 0.01 N Aqueous NaOH Solution and Standardization:

10 ml of a 1 N aqueous NaOH solution was added into a volumetric flask (1 L) and was diluted to a volume of 1 L with deionized water to prepare a 0.01 N aqueous NaOH solution.

0.018 g of potassium biphthalate was dissolved in 20 g of deionized water, followed by addition of 30 g of acetone to prepare a potassium biphthalate solution. The potassium biphthalate solution was then titrated with the 0.01 N aqueous NaOH solution using an autotritrator (Manufacturer: Metrohm AG; Model: 888 Titrando). The consumed volume of the 0.01 N aqueous NaOH solution was recorded when the endpoint of the titration was reached. The concentration of the NaOH solution after standardization was calculated according to the formula below:

C_{N}=W_{KHP}/(0.20422×V_{NaoH}))

wherein
C_{N}: Concentration of the aqueous NaOH solution after standardization, i.e. normality of the aqueous NaOH solution;
W_{KHP}: Weight of potassium biphthalate, in gram (g); and
V_{NaOH}: Consumed volume of the 0.01 N aqueous NaOH solution, in milliliter (ml).

### (ii) Measurement of Acid Value:

A proper amount of a polyester polyol product was weighed and used as a sample, which was then dissolved in 50 g of a solvent mixture of acetone and methanol in a volume ratio of 1:1 to prepare a sample solution. Another 50 g of the solvent mixture of acetone and methanol in a volume ratio of 1:1 was added into a vessel to be used as a blank sample. Each of the sample solution and the blank sample was titrated with the 0.01 N aqueous NaOH solution using the autotritrator until the endpoint of the titration was reached. The consumed volume of the 0.01 N aqueous NaOH solution for the titration of each of the sample solution and the blank sample was recorded. The acid value of the polyester polyol product was calculated according to the formula below:

Acid Value (mg KOH/g)=[(Vₐ−V_{b})×C_{N}×56.1]/W

wherein
Vₛ: Consumed volume (in ml) of the 0.01 N aqueous NaOH solution for the sample solution;
V_{b}: Consumed volume (in ml) of the 0.01 N aqueous NaOH solution for the blank sample;
C_{N}: normality of aqueous NaOH solution; and
W: Weight (in g) of the sample.

### 3. Hydroxyl Value:

### (i) Preparation of a Titrant Solution:

100 ml of a 1 N aqueous tetrabutylammonium hydroxide (Bu₄NOH, TBAH) solution was diluted to a volume of 1 L with isopropanol to prepare a 0.1 N TBAH titrant solution.

### (ii) Measurement of Hydroxyl Value:

A proper amount of a polyester polyol product was weighed and used as a sample, which was then formulated into a sample solution according to ASTM E 1899. The sample solution was titrated with the 0.1 N TBAH titrant solution using the autotritrator. The consumed volumes (V₁, V₂) of the 0.1 N TBAH titrant solution at the first and second endpoints of the titration were recorded. The hydroxyl value of the polyester polyol product was calculated according to the formula below:

Hydroxyl Value (mg KOH/g)=[(V₂−V₁)×N×56.1]/W

wherein
V₁: Consumed volume (in ml) of the 0.1 N TBAH titrant solution at the first endpoint of the titration;
V₂: Consumed volume (in ml) of the 0.1 N TBAH titrant solution at the second endpoint of the titration;
N: Normality of the 0.1 N TBAH titrant solution; and
W: Weight (in g) of the sample.

### 4. Viscosity:

Viscosity (in cP) of a polyester polyol product was measured at 25° C. using a viscometer (Model: Brookfield DV-111 ULTRA) after reaction was completed.

### Example 1

Terephthalic acid (50 g, 100 parts by weight (pbw)), phthalic acid (90.5 g, 181 pbw), and sodium carbonate (Na₂CO₃, 0.0647 g, 200 ppm) were mixed in a two-necked flask (500 ml) to obtain a pre-mixture. Ethylene glycol (66 g, 132 pbw) and diethylene glycol (117 g, 234 pbw) were then added into the two-necked flask and mixed with the pre-mixture under stirring at 400 rpm to obtain a mixture.

The two-necked flask was then installed with a simple distillation device. The mixture in the two-necked flask was heated to a temperature of 200° C., which was maintained for 30 min. After that, titanium n-butoxide (300 ppm, as a catalyst) was added and nitrogen gas was fed into the two-necked flask at a flow rate of 500 ml/min, followed by a reaction for 4 hours. Sampling was then taken every hour, and the acid value and the hydroxyl value of each sample was measured according to the measurement procedures described above. When the acid value was less than 5 mg KOH/g, the heating under stirring was stopped to terminate the reaction, thereby obtaining the polyester polyol product. The total reaction time was recorded. The polyester polyol product was poured out of the two-necked flask when the reaction temperature was lowered to 50 to 70° C. The acid value, the hydroxyl value, the viscosity, and the alkali metal ion content of the polyester polyol product were measured according to the measurement processes described above, and the appearance of the polyester polyol product was observed. The results are shown in Table 1 below.

### Examples 2 to 6

Each of Examples 2 to 6 was implemented according to the procedure of Example 1 except that the alkali metal ion-containing compounds specified for Examples 2 to 6 in Table 1 were used in place of sodium carbonate (Na₂CO₃) used in Example 1. The acid value, the hydroxyl value, the viscosity, and the alkali metal ion content of each of the polyester polyol products of Examples 2 to 6 were measured according to the measurement procedures described above, and the appearance of each of the polyester polyol products of Examples 2 to 6 was observed. The results are shown in Table 1 below.

### Examples 7 to 9

Each of Examples 7 to 9 was implemented according to the procedure of Example 1 except that the amounts of sodium carbonate specified in Table 2 were used in Examples 7 to 9. The acid value, the hydroxyl value, the viscosity, and the alkali metal ion content of each of the polyester polyol products of Examples 7 to 9 were measured according to the measurement procedures described above, and the appearance of each of the polyester polyol products of Examples 7 to 9 was observed. The results are shown in Table 2 below.

### Examples 10 and 11

Each of Examples 10 and 11 was implemented according to the procedure of Example 1 except that isophthalic acid was used in Examples 10 and 11 in place of phthalic acid used in Example 1 and that fumaric acid was further included in the mixture in Example 10, and maleic anhydride was further included in the mixture in Example 11. The acid value, the hydroxyl value, the viscosity, and the alkali metal ion content of each of the polyester polyol products of Examples 10 and 11 were measured according to the measurement procedures described above, and the appearance of each of the polyester polyol products of Examples 10 and 11 was observed. The results are shown in Table 2 below.

### Comparative Example 1

Comparative Example 1 was implemented according to the procedure of Example 1 except that Na₂CO₃ was not used in Comparative Example 1. The acid value, the hydroxyl value, the viscosity, and the alkali metal ion content of the polyester polyol product of Comparative Example 1 were measured according to the measurement procedures described above, and the appearance of the polyester polyol product of Comparative Example 1 was observed. The results are shown in Table 3 below.

### Comparative Examples 2 to 5

Each of Comparative Examples 2 to 5 was implemented according to the procedure of Example 1 except that other metal ion-containing compounds specified in Table 3 were used in Comparative Examples 2 to 5 in place of Na₂CO₃ used in Example 1. The acid value, the hydroxyl value, and the viscosity of each of the polyester polyol products of Comparative Examples 2 to 5 were measured according to the measurement procedures described above, and the appearance of each of the polyester polyol products of Comparative Examples 2 to 5 was observed. The results are shown in Table 3 below.

### Comparative Example 6

Comparative Example 6 was implemented according to the procedure of Example 1 except that the amount of Na₂CO₃ specified in Table 3 was used. The acid value, the hydroxyl value, the viscosity, and the alkali metal ion content of the polyester polyol product were measured according to the measurement procedures described above, and the appearance of the polyester polyol product of Comparative Example 6 was observed. The results are shown in Table 3 below.

### Comparative Examples 7 and 8

Comparative Examples 7 and 8 were implemented according to the procedures of Examples 10 and 11, respectively except that Na₂CO₃ was not used. The acid value, the hydroxyl value, and the viscosity of each of the polyester polyol products of Comparative Examples 7 and 8 were measured according to the measurement procedures described above, and the appearance of each of the polyester polyol products of Comparative Examples 7 and 8 was observed. The results are shown in Table 4 below.

TABLE 1

| | | Ex. | | | | | |
|---|---|---|---|---|---|---|---|
| | | 1 | 2 | 3 | 4 | 5 | 6 |
| Amount of | PTA | 100 | 100 | 100 | 100 | 100 | 100 |
| aromatic diacid-based | PA | 181 | 181 | 181 | 181 | 181 | 181 |
| compound (pbw) | IPA | 0 | 0 | 0 | 0 | 0 | 0 |
| Amount of aliphatic | EG | 132 | 132 | 132 | 132 | 132 | 132 |
| diol (pbw) | DEG | 234 | 234 | 234 | 234 | 234 | 234 |
| Alkali metal | Type | Na₂CO₃ | NaOH | NaHCO₃ | KaCl | Na₂SO₄ | KOH |
| ion-containing | Amount (ppm) | 200 | 200 | 200 | 200 | 200 | 200 |
| compound | | | | | | | |
| Alkali metal | Theoretical content (ppm)^{a} | 86.8 | 115 | 54.8 | 78.8 | 64.8 | 139.3 |
| ion content | Practical content (ppm)^{b} | 84.01 | 112.3 | — | — | 62.7 | — |
| Reaction time (hr) | | 5.5 | 5 | 5 | 5.5 | 5.5 | 5 |
| Properties of | Acid value (mg KOH/g) | 2 | 1.4 | 2.3 | 2.1 | 1.9 | 2.8 |
| polyester polyol | Hydroxyl value (mg KOH/g) | 352 | 354 | 348 | 351 | 349 | 345 |
| product | Viscosity (cP) | 6000 | 5920 | 6070 | 6015 | 6038 | 6100 |
| | Appearance | Transparent | Transparent | Transparent | Transparent | Transparent | Transparent |
| | | and colorless | and colorless | and colorless | and colorless | and colorless | and colorless |

TABLE 2

| | | Ex. | | | | |
|---|---|---|---|---|---|---|
| | | 7 | 8 | 9 | 10 | 11 |
| Amount of aromatic | PTA | 100 | 100 | 100 | 100 | 100 |
| diacid-based compound | PA | 181 | 181 | 181 | 0 | 0 |
| (pbw) | IPA | 0 | 0 | 0 | 83.5 | 83.3 |
| Amount of aliphatic diol | EG | 132 | 132 | 132 | 132 | 132 |
| (pbw) | DEG | 234 | 234 | 234 | 234 | 234 |
| Amount of aliphatic | FA | 0 | 0 | 0 | 83.5 | 0 |
| diacid-based compound | MA | 0 | 0 | 0 | 0 | 70.7 |
| (pbw) | | | | | | |
| Alkali metal ion-containing | Type | Na₂CO₃ | Na₂CO₃ | Na₂CO₃ | Na₂CO₃ | Na₂CO₃ |
| compound | Amount (ppm) | 2000 | 12000 | 24000 | 200 | 200 |
| Alkali metal ion content | Theoretical content (ppm)^{a} | 867.9 | 5207.5 | 10415.1 | 86.8 | 86.8 |
| | Practical content (ppm)^{b} | — | 5088.6 | — | 83.2 | — |
| Reaction time (hr) | | 5 | 5.5 | 5 | 6 | 6.5 |
| Properties of polyester | Acid value (mg KOH/g) | 1.6 | 2.2 | 1.8 | 2 | 2.6 |
| polyol product | Hydroxyl value (mq KOH/q) | 361 | 367 | 372 | 332 | 329 |
| | Viscosity (cP) | 5640 | 5170 | 4890 | 5760 | 5830 |
| | Appearance | Transparent | Transparent | Transparent | Transparent | Transparent |
| | | and colorless | and colorless | and colorless | and yellow | and orange |

TABLE 3

| | | Comb. Ex. | | | | | |
|---|---|---|---|---|---|---|---|
| | | 1 | 2 | 3 | 4 | 5 | 6 |
| Amount of aromatic | PTA | 100 | 100 | 100 | 100 | 100 | 100 |
| diacid-based compound | PA | 181 | 181 | 181 | 181 | 181 | 181 |
| (pbw) | IPA | 0 | 0 | 0 | 0 | 0 | 0 |
| Amount of aliphatic | EG | 132 | 132 | 132 | 132 | 132 | 132 |
| diol (pbw) | DEG | 234 | 234 | 234 | 234 | 234 | 234 |
| metal ion-containing | Type | None | Mg(OH)₂ | Ca(OH)₂ | Ba(OH)₂ | AlCl₃ | Na₂CO₃ |
| compound | Amount (ppm) | 0 | 200 | 200 | 200 | 200 | 30000 |
| metal ion content | Theoretical content (ppm)^{a} | 0 | 83.4 | 108.1 | 160.3 | 40.5 | 13018.9 |
| | Practical content (ppm)^{b} | 0 | — | — | — | — | — |
| Reaction time (hr) | | 5 | 5.5 | 5.5 | 5 | 5 | 5 |
| Properties of polyester | Acid value (mg KOH/q) | 1 | 1.7 | 2.5 | 1.4 | 2.1 | 2 |
| polyol product | Hydroxyl value (mq KOH/q) | 290 | 301 | 305 | 310 | 294 | 376 |
| | Viscosity (cP) | 29000 | 24620 | 23340 | 21560 | 28530 | 4513 |
| | Appearance | Transparent | Transparent | Transparent | Transparent | Transparent | Cloudy |
| | | and colorless | and colorless | and colorless | and colorless | and colorless | |

TABLE 4

| | | Comp. Ex. | |
|---|---|---|---|
| | | 7 | 8 |
| Amount of aromatic | PTA | 100 | 100 |
| diacid-based | PA | — | — |
| compound (pbw) | IPA | 83.5 | 83.3 |
| Amount of aliphatic | EG | 132 | 132 |
| diol (pbw) | DEG | 234 | 234 |
| Amount of aliphatic | FA | 83.5 | 0 |
| diacid-based | | | |
| compound (pbw) | MA | 0 | 70.7 |
| Alkali metal ion- | Type | None | None |
| containing compound | Amount (ppm) | 0 | 0 |
| Alkali metal | Theoretical | 0 | 0 |
| ion content | content (ppm)^{a} | | |
| | Practical | 0 | 0 |
| | content (ppm)^{b} | | |
| Reaction time (hr) | | 6 | 6.5 |
| Properties | Acid value | 2.3 | 2.1 |
| of polyester | (mg KOH/g) | | |
| polyol product | Hydroxyl value | 287 | 285 |
| | (mg KGH/g) | | |
| | Viscosity (cP) | 28130 | 28540 |
| | Appearance | Transparent | Transparent |
| | | and yellow | and orange |

### Note:

a: (weight % of metal in a metal ion-containing compound) x the amount of the compound
b: analyzed using an inductively coupled plasma mass spectrometer
−: not measured

As shown in Table 3, in Comparative Example 1, the alkali metal ion-containing compound was not added in the mixture for preparing the polyester polyol, and the polyester polyol thus produced has a viscosity of 29000 cP. As shown in Table 1, in Examples 1 to 6, a proper amount of the alkali metal ion-containing compound was added in the mixture for preparing the polyester polyol, and the polyester polyol thus produced has a significantly low viscosity (i.e., from 5920 cP to 6100 cP) with a transparent and colorless appearance.

By comparing the results of Example 1 in Table 1 to those of Examples 7 to 9 in Table 2, it is found that the viscosity of the polyester polyol thus produced is lowered more significantly and the appearance thereof is still transparent and colorless when the sodium ion content is increased.

By comparing the results of Example 1 in Table 1 to those of Examples 10 and 11 in Table 2, it is found that when a proper amount of the alkali metal ion-containing compound was added in the mixture for preparing the polyester polycol which additionally includes the aliphatic diacid-based compound, the polyester polyol thus produced also has a significantly low viscosity. In addition, by comparing the results of Examples 10 and 11 in Table 2 to those of Comparative Examples 7 and 8 in Table 4, it is demonstrated that the viscosity of the polyester polyol thus produced can be effectively lowered by adding a proper amount of the alkali metal ion-containing compound in the mixture for preparing the polyester polyol.

By comparing the results of Example 1 in Table 1 to those of Comparative Examples 2 to 5 in Table 3, it is found that when the metal ion-containing compound other than the alkali metal ion-containing compound is included in the mixture for preparing the polyester polyol, the viscosity of the polyester polyol thus produced is in a range from 21560 cP to 28530 cP. It is thus demonstrated that the viscosity of the polyester polyol cannot be effectively lowered by adding the metal ion-containing compound other than the alkali metal ion-containing compound in the mixture for preparing the polyester polyol.

The results of Comparative Example 6 in Table 3 show that when the alkali metal ion content in the alkali metal ion-containing compound is too large (>13000 ppm), the polyester polyol thus produced has a cloudy appearance even though the viscosity of the polyester polyol can be effectively lowered. While not wishing to be bound by any theory, it is believed that an excess amount of the alkali metal ion-containing compound may not be miscible with the aliphatic diol compound and/or other polyol compounds, and also may not be more effectively reacted with the aromatic diacid-based compound and/or the aliphatic diol compound such that a portion of the alkali metal ion-containing compound is precipitated, resulting in a cloudy appearance of the polyester polyol thus produced.

In addition, the theoretical content and the practical content of the alkali metal ion in the alkali metal ion-containing compound in each of Examples 1, 2, 5, 8, and 10 and Comparative Example 1 are summed as follow.

| | Comp. | | | | | |
|---|---|---|---|---|---|---|
| | Ex. 1 | Ex. 1 | Ex. 2 | Ex . 5 | Ex. 8 | Ex. 10 |
| Theoretical | 0 | 86.8 | 115 | 64.8 | 5207.5 | 86.8 |
| content of alkali | | | | | | |
| metal ion (ppm) | | | | | | |
| Practical content | 0 | 84.01 | 112.3 | 62.7 | 5088.6 | 83.2 |
| of alkali metal | | | | | | |
| ion (ppm) | | | | | | |
| Reaction time (hr) | 5 | 5.5 | 5 | 5.5 | 5.5 | 6 |

As shown above, in Example 1, the theoretical content of alkali metal ion (i.e., the content of the alkali metal ion contained in the alkali metal ion-containing compound before the reaction for producing the polyester polyol) is 86.8 ppm, and the practical content of alkali metal ion (i.e., the content of the alkali metal ion contained in the polyester polyol product obtained after the reaction) is 84.01 ppm, which is of very little difference from the theoretical content of alkali metal ion, indicating that the alkali metal ion-containing compound is effectively used as an end-capping agent in the reaction for producing the polyester polyol. In addition, the reaction times in Example 1 and Comparative Example 1 are 5.5 hours and 5 hours, respectively, indicating that the alkali metal ion-containing compound is not used as a catalyst to increase the reaction rate for producing the polyester polyol. Examples 2, 5, 8, and 10 have the same results as Example 1.

In view of the aforesaid, in the process for producing a low viscosity polyester polyol according to the disclosure, the reaction of the aromatic dicarboxylic acid-based compound with the aliphatic diol compound is controlled via addition of the alkali metal ion-containing compound so as to produce the low viscosity polyester polyol.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A process for producing a low viscosity polyester polyol, comprising the steps of:
(a) preparing a mixture which includes an aromatic diacid-based compound, an alkali metal ion-containing compound, and an aliphatic diol compound; and
(b) subjecting the mixture to a reaction,
wherein the alkali metal ion-containing compound has an alkali metal ion content of from 10 ppm to 12000 ppm based on a total weight of the mixture.

2. The process according to claim 1, wherein step (a) includes the sub-steps of:
(a1) premixing the aromatic diacid-based compound with the alkali metal ion-containing compound to obtain a pre-mixture; and
(a2) mixing the pre-mixture with the aliphatic diol compound to obtain the mixture.

3. The process according to claim 1, wherein the alkali metal ion-containing compound is selected from the group consisting of an alkali metal hydroxide, an alkali metal salt, and a combination thereof.

4. The process according to claim 3, wherein the alkali metal hydroxide is selected from the group consisting of sodium hydroxide, potassium hydroxide, and a combination thereof.

5. The process according to claim 3, wherein the alkali metal salt is selected from the group consisting of sodium carbonate, sodium hydrocarbonate, sodium chloride, sodium sulfate, potassium carbonate, and combinations thereof.

6. The process according to claim 1, wherein the aromatic diacid-based compound is a benzenedicarboxylic acid-based compound.

7. The process according to claim 6, wherein the benzenedicarboxylic acid-based compound is selected from the group consisting of phthalic acid, phthalic anhydride, terephthalic acid, isophthalic acid, and combinations thereof.

8. The process according to claim 1, wherein the mixture further includes an aliphatic diacid-based compound selected from the group consisting of an aliphatic diacid compound, an aliphatic dianhydride compound, and a combination thereof.

9. The process according to claim 8, wherein the aliphatic diacid-based compound is the aliphatic diacid compound.

10. The process according to claim 9, wherein the aliphatic diacid compound is selected from the group consisting of maleic acid, fumaric acid, and a combination thereof.

11. The process according to claim 8, wherein the aliphatic diacid-based compound is the aliphatic dianhydride compound.

12. The process according to claim 11, wherein the aliphatic dianhydride compound is maleic anhydride.
